(19) United States
(12) Patent Application Publication
(10) Pub. No.: US 2003/0182096 A1
(43) Pub. Date: Sep. 25, 2003

(54) Analog-digital converter cell, simulation apparatus, and simulation method

(75) Inventor: Junzo Mori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/364,471

(22) Filed: Feb. 12, 2003

(30) Foreign Application Priority Data
Mar. 19, 2002 (JP) 2002-075482

(51) Int. Cl. G06F 17/50

(52) U.S. Cl. 703/14

(57) ABSTRACT

A circuit includes both an analog-digital converter cell and a digital cell. The circuit has six digital input terminals and one analog input terminal. Similarly, the analog-digital converter cell has six digital input terminals, six digital output terminals, and one analog input terminal. The digital input terminals of the circuit are connected to the digital input terminals of the analog-digital converter cell and in turn to the digital output terminals of the analog-digital converter cell. The signals output from the analog-digital converter cell are input to the digital cell. Test patterns are input to the digital input terminals of the circuit. The circuit has four output terminals. Whether the wiring connection between the analog-digital converter cell and the digital cell is correct is determined based on signals output from the circuit.

### CROSS-REFERENCE TO RELATED APPLICATIONS

This application is based upon and claims the benefit of priority from the prior Japanese Patent Application No. 2002-075482, filed on Mar. 19, 2002, the entire contents of which are incorporated herein by reference.

### BACKGROUND OF THE INVENTION

1) Field of the Invention

The present invention relates to an analog-digital converter (ADC) cell to be used in simulation of a circuit that includes both the analog-digital converter cells and the digital cells. The present invention also relates to a method of and an apparatus for simulating the circuit.

2) Description of the Related Art

Typical logic simulators used in development stages of large scale integrated circuits (LSI) handle only digital data. Therefore, logic simulation of input and output signals of analog cells cannot be conducted finely. It poses a problem when developing LSI's that includes both the analog and digital cells.

Conventionally, mixed signal simulators, which conduct simulation on a circuit that includes both the analog and digital cells, are known. However, the mixed signal simulators are inconvenient to operate. Therefore, the mixed signal simulators are not used in the circuit design of large scale digital circuits that include both the analog-digital and digital-analog converters. As a result, conventionally, the logic simulator is used to operation and validation of the analog-digital and digital-analog converters.

FIG. 3 shows a functional block diagram of the conventional logic simulator. A circuit model 14, which includes both an analog-digital converter cell (ADC) 12 and a digital cell (logic) 13, is constructed based on a net list (with only AIN) 11. The net list 11 has only connection information of an analog input terminal AIN. An analog signal test pattern 15 is input to the circuit model 14. The circuit model 14 and operation will now be explained in detail by taking a 6-bit analog-digital converter cell as an example.

FIG. 2 shows a detailed diagram of the circuit model 14. The circuit mode 14 has the analog input terminal AIN, and four output terminals OUT1 to OUT4. The analog-digital converter cell 12 has six digital output terminals D0 to D5. The digital cell (random logic) 13 has an AND gate 21, a first inverter 22, a second inverter 23, and an NAND gate 24.

If a signal of value “1” is input to the analog input terminal AIN, then the analog-digital converter cell 12 outputs “111111” from the digital output terminals D0 to D5. If a signal of value “0” is input to the analog input terminal AIN, then the analog-digital converter cell 12 outputs “000000” from the digital output terminals D0 to D5 (refer to Japanese Patent Application Laid-Open Publication No. 9-26985 for details).

In reality, voltage is input to the analog input terminal AIN and not values. The lowest voltage among the voltages input from the analog input terminal AIN is considered by the analog-digital converter cell 12 as input of the value “0” and the highest voltage considered as the input of value “1.”

There is a problem with the conventional simulator that, the output of the analog-digital converter 12 is either “111111” or “000000”, so that simulation for other outputs cannot be conducted. In the example shown in FIG. 2, the outputs from the terminals D0 and D1 of the analog-digital converter 12 are input to the AND gate 21 in the digital cell 13, the output from the terminal D2 is input to the first inverter 22, the output from the terminal D3 is input to the second inverter 23, and the outputs from the terminals D4 and D5 are input to the NAND gate 24.

Because of such a configuration, even if the connection relation of the output terminals of the analog-digital converter cell 12 is incorrect, signals having the same values as those obtained when the connection relation is correct are output from the output terminals OUT1 to OUT4. This results in a problem that it is incorrect wiring can not be detected.

### SUMMARY OF THE INVENTION

It is an object of the present invention to provide an analog-digital converter cell which makes it possible to correctly verify a circuit that includes both the analog digital converter cells and the digital cells. It is another object of the present invention to provide a method of and an apparatus for simulating such circuits.

According to the analog-digital converter cell of one aspect of the present invention, the analog-digital converter cell has an analog input terminal, a plurality of digital output terminals, and digital input terminals in a number same as the digital output terminals.

The simulation apparatus of another aspect of the present invention conducts simulation on a circuit that includes an analog-digital converter cell and a digital cell. The analog-digital converter cell comprises a plurality of digital output terminals and digital input terminals in number same as the digital output terminals. The simulation apparatus has a digital test pattern generation unit that generates a digital test pattern for inputting to each of the digital input terminals, and a verifying unit that verifies the wiring connection between the analog-digital converter cell and the digital cell based on the signals output from the circuit.

The simulation method another aspect of the present invention conducts simulation on a circuit that includes an analog-digital converter cell and a digital cell. The analog-digital converter cell comprises a plurality of digital output terminals and digital input terminals in number same as the digital output terminals. This method comprises generating a digital test pattern for inputting to each of the digital input terminals, and verifying the wiring connection between the analog-digital converter cell and the digital cell based on the signals output from the circuit.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a diagram which shows a system configuration used when simulation of a circuit (mixture circuit), which includes both the analog-digital converter cells and the digital cells, is conducted by using a logic simulator according to the conventional art,

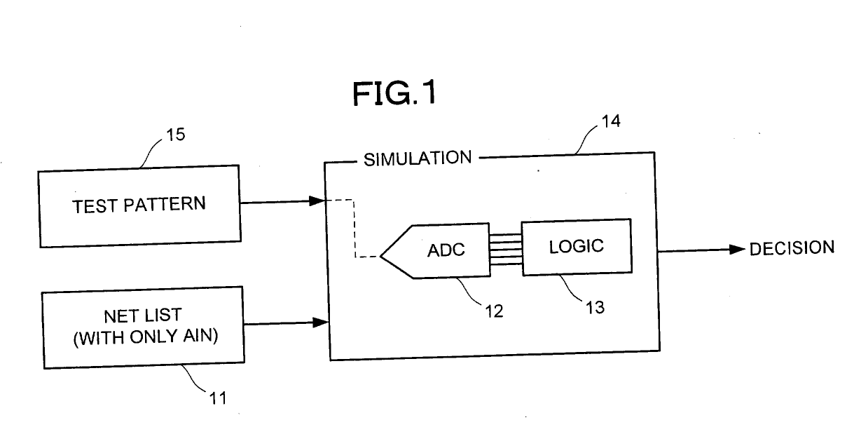

FIG. 2 is a diagram which shows a detailed configuration of a conventional circuit model,

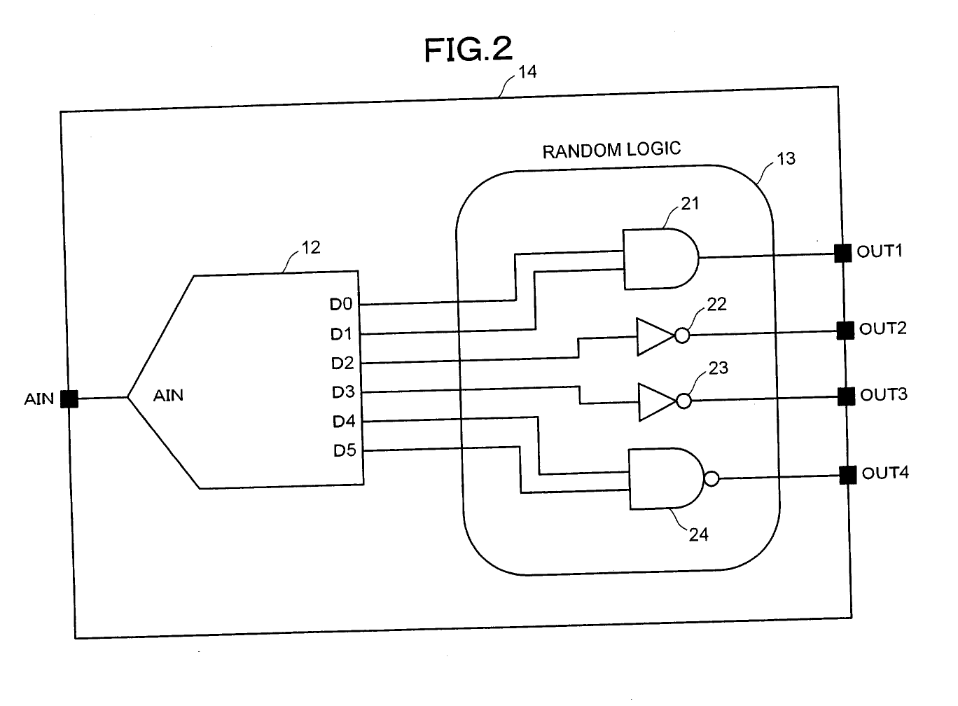

FIG. 3 is a diagram which shows a system configuration used when simulation of a mixture circuit is conducted by using a logic simulator according to the present invention, and

FIG. 4 is a diagram which shows a detailed configuration of a circuit model according to the present invention.

### DETAILED DESCRIPTIONS

Embodiments of the present invention will be explained in detail with reference to the accompanying drawing.

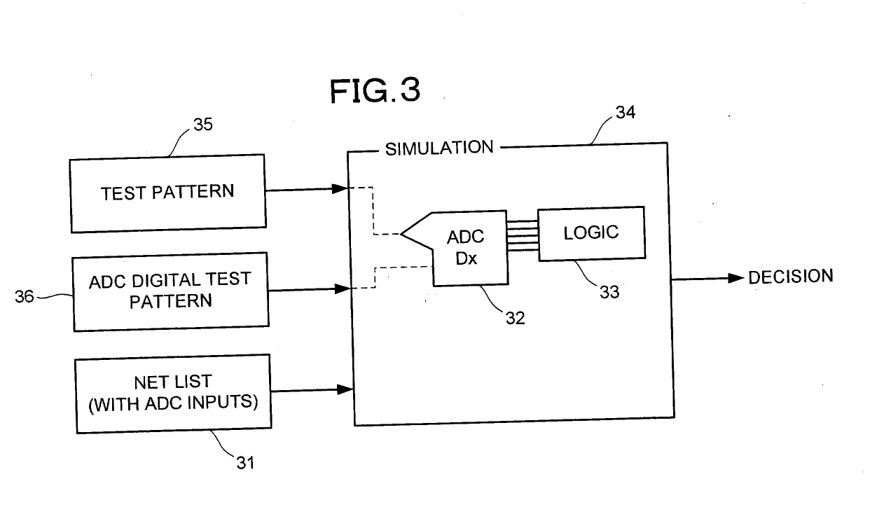

FIG. 3 is a diagram which shows a system configuration used when simulation of a mixture circuit is conducted by using a logic simulator according to the present invention. A circuit model 34, which includes both an analog-digital converter cell 32 and a digital cell 33, is constructed based on a net list (with ADC inputs) 31. The net list 31 has the connection information of a digital input terminal Dx (where x is a variable) along with the connection information of the analog input terminal AIN. Moreover, an analog test pattern 35 and an ADC digital test pattern 36, which is different from the test pattern 35, is input to the circuit model 34. The circuit model 34 and operation will now be explained in detail by taking a 6-bit analog-digital converter cell as an example.

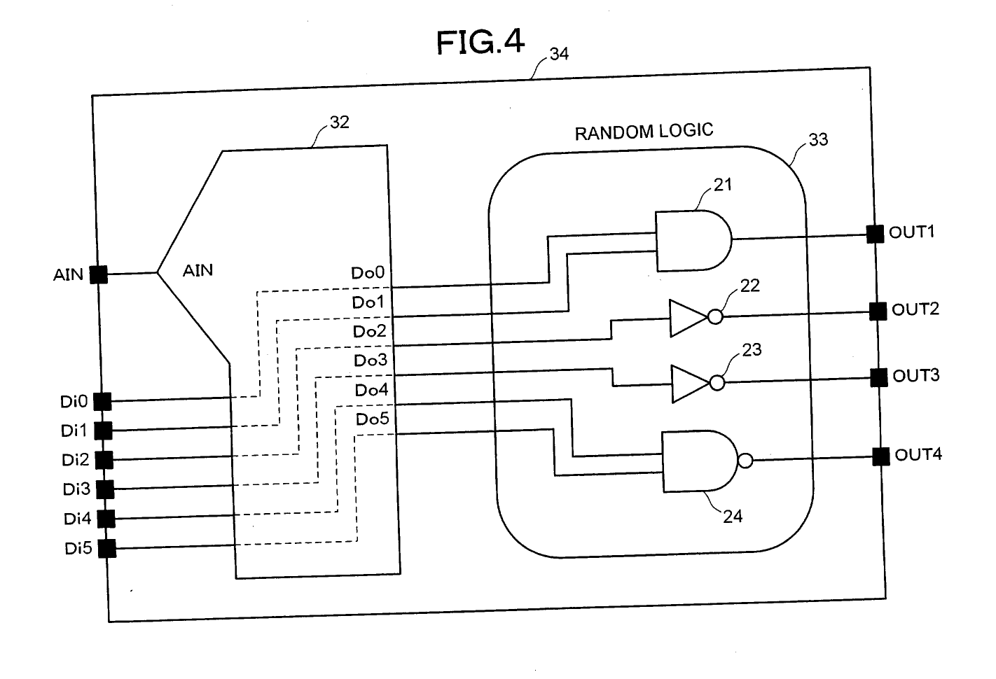

FIG. 4 shows a detailed diagram of the circuit model 14. The circuit mode 14 has the analog input terminal AIN, six digital input terminals Di0 to Di5, and four output terminals OUT1 to OUT4. The signals input to the digital input terminals Di0 to Di5, in addition to the signal input to the analog input terminal AIN, are supplied to the analog-digital converter cell 32. The analog-digital converter cell 32 has six digital output terminals Do0 to Do5. The digital input terminals Di0 to Di5 and the digital output terminals Do0 to Do5 have a one-to-one correspondence.

The digital signals input to the terminals Di0 to Di5 are output as they are from the terminals Do0 to Do5. In other words, signals output from any one of the terminals Do0 to Do5 can be set equal to “0” or “1” as desired.

The digital cell (random logic) 33 has the AND gate 21, the first inverter 22, the second inverter 23, and the NAND gate 24. The signals output from the terminals Do0 and Do1 are input to the AND gate 21, the signals output from the terminal Do2 is input to the first inverter 22, the signals output from the terminal Do3 is input to the second inverter 23, and the signals output from the terminals Do4 and Do5 are input to the NAND gate 24.

Assume that a signal of value “0” is input to the terminals Di0 to Di3 and a signal of value “1” is input to the terminals Di4 and Di5. In this case, if the wiring relation between the digital output terminals Do0 to Do5 and the digital cell 33 is correct, then “0” is output from the output terminal OUT1, “1” is output from the output terminals OUT2 and OUT3, and “0” is output from the output terminal OUT4. If the wiring relation between the digital output terminals Do0 to Do5 and the digital cell 33 is wrong, then “1” is output from all the four output terminals OUT1 to OUT4. Thus, different output can be obtained based on whether the wiring relation is correct or wrong. As a result, it can be decided from the output whether the wiring relation between the analog-digital converter cell 32 and the digital cell 33 is correct or wrong.

If, for example, the wiring connection between the terminals Do3 and Do4 and the digital cell 33 is opposite, then the output at the output terminal OUT3 will be “0” and that at the terminal OUT4 will be “1.” Since the signals are different from the case when the wiring connection is correct, it can be decided that the wiring connection between the analog-digital converter cell 32 and the digital cell 33 is wrong.

The signals to be input to the terminals Di0 to Di5 may be generated using know technology. Moreover, the signals output from the terminals OUT1 to OUT4 can be detected using know technology.

According to the embodiment, it is possible to output digital signals of various test patterns from the analog-digital converter cell 32. As a result, if the wiring connection between the analog-digital converter cell 32 and the subsequent digital cell 33 wrong, then signals that are different from when the wiring connection is correct are output from the digital cell 33. As a result, it is possible to verify incorrect wiring.

The present invention is not limited to the above embodiment, but various changes can be effected. For example, the analog-digital converter cell is not limited to 6-bits, but 4-bits, 8-bits or a number of bits other than them may also be used. It is also possible to alter the configuration of the digital cell 33 as desired.

According to the present invention, digital signals of various test patterns are output from the analog-digital converter cell. If the wiring between the analog-digital converter cell and the subsequent digital cell is incorrect, then signals that are different from when the wiring is correct are output from the digital cell. As a result, it is possible to easily verify the wiring is correct or wrong.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An analog-digital converter cell to be used in simulation of a circuit, wherein the circuit includes the analog-digital converter cell and a digital cell, the analog-digital converter cell comprising:
an analog input terminal;
a plurality of digital output terminals; and
digital input terminals in a number same as the digital output terminals.

2. The analog-digital converter cell according to claim 1, wherein the analog-digital converter cell is a 6-bit analog-digital converter cell.

3. A simulation apparatus which conducts simulation on a circuit, wherein the circuit includes an analog-digital converter cell and a digital cell, and the analog-digital converter cell comprises a plurality of digital output terminals and digital input terminals in number same as the digital output terminals, the simulation apparatus comprising:
a digital test pattern generation unit that generates a digital test pattern for inputting to each of the digital input terminals; and
a verifying unit that verifies the wiring connection between the analog-digital converter cell and the digital cell based on the signals output from the circuit.

4. The simulation apparatus according to claim 3, wherein the analog-digital converter cell is a 6-bit analog-digital converter cell.

5. A simulation method of conducting simulation on a circuit, wherein the circuit includes an analog-digital converter cell and a digital cell, and the analog-digital converter cell comprises a plurality of digital output terminals and digital input terminals in number same as the digital output terminals, comprising:
generating a digital test pattern for inputting to each of the digital input terminals; and
verifying the wiring connection between the analog-digital converter cell and the digital cell based on the signals output from the circuit.

6. The simulation method according to claim 5, wherein the analog-digital converter cell is a 6-bit analog-digital converter cell.
